(19) United States
(12) Patent Application Publication
(10) Pub. No.: US 2024/0020138 A1
(43) Pub. Date: Jan. 18, 2024

(54) METHOD AND SYSTEM FOR EFFICIENTLY LAUNCHING APPLICATIONS AND FILES LOCATED ON REMOTE DESKTOPS

(71) Applicant: VMware, Inc., Palo Alto, CA (US)

(72) Inventor: Lin LV, Beijing (CN)

(21) Appl. No.: 17/934,332

(22) Filed: Sep. 22, 2022

(30) Foreign Application Priority Data
Jul. 14, 2022 (WO) PCT/CN2022/105670

(51) Int. Cl. G06F 9/451; G06F 9/455

(52) U.S. Cl. CPC G06F 9/452; G06F 9/45558; G06F 2009/45595

(57) ABSTRACT

The disclosure provides a method of seamlessly launching at least one of applications or files located on remote desktops. The method generally includes receiving, at a connection server, application information for an application located on a first remote desktop in response to a first request from a client device to add the application to the connection server, receiving, at the connection server, from the client device, a second request to launch the application, validating, at the connection server, the second request based on credentials included in the second request, and forwarding, to the first remote desktop, the second request based on validating the second request, wherein, based on the second request, the first remote desktop launches the application for display at the client device.

### CROSS-REFERENCE TO RELATED APPLICATIONS

This application claims priority to International Patent Application No. PCT/CN2022/105670, filed Jul. 14, 2022, entitled “METHOD AND SYSTEM FOR EFFICIENTLY LAUNCHING APPLICATIONS AND FILES LOCATED ON REMOTE DESKTOPS”, and assigned to the assignee hereof, the contents of which are hereby incorporated by reference in its entirety.

### BACKGROUND

In a virtual desktop infrastructure (VDI) environment, a local client device (e.g., a personal computer (PC) or mobile device) can access a remote virtual or physical desktop, a remote application that is running on a remote device, or a remote file at the remote device. For instance, a virtual desktop may be hosted on a central infrastructure known as VDI, and may be rendered on a client device using a remote display protocol. At the client device, a user may interact with the virtual desktop using peripheral devices (e.g., keyboard and/or mouse) associated with the client device, and operating system (OS) events generated based on the user's inputs are captured by a VDI client (e.g., a user-side interface of the remote desktop) of the client device and redirected from the client device to the remote device on which the virtual desktop is located.

As mentioned, an end user (e.g., a user of a local client device) of a remote desktop may use applications installed on the remote desktop and/or access files located on the remote desktop. For example, an application that the user desires to use may be installed only on a particular remote desktop. Accordingly, the user may connect to the particular remote desktop (e.g., from the local client device), navigate to the application, and launch the application on the remote desktop. The application may be rendered on the client device using a remote display protocol.

In some cases, applications and/or files which an end user desires to access, using a local client device, are located on multiple remote desktops. For example, at a first time, a user may desire to open a first file on a first remote desktop using a local application. At a second time (e.g., later in time than the first time), the user may desire to open a second file on a second remote desktop using the local application. In such a case, the user, at the first time, may connect a local client device to the first remote desktop, navigate to a target folder on the remote desktop where the first file is located, transfer the first file to the local client device, switch to the local desktop, and open the first file from the local desktop with the desired local application. At the second time, the user may connect the local client device to the second remote desktop, navigate to a target folder on the second remote desktop where the second file is located, transfer the second file to the local client device, switch to the local desktop, and open the second file from the local desktop with the desired local application. Transferring files and switching between the remote and local desktops takes time and reduces efficiency for the user. In particular, for a user that is using only one display screen/monitor, switching between remote and local desktop provides a poor user experience and further reduces the user's productivity. Further, having a connection to multiple remote desktops to access different applications and/or files located on those remote desktops increases resource consumption on both local and remote desktop devices.

In some cases, applications and files which an end user desires to use (e.g., with a local client device) are located on multiple remote desktops. In particular, an application that a user desires to use may only be installed on a first remote desktop, while a file which the user desires to open using the application on the first remote desktop is located only on a second remote desktop. As an illustrative example, a user may desire to edit documents on a second remote desktop using a particular word processing application installed on the first remote desktop. Unfortunately, today, there is no direct method for users to open the file located on the second remote desktop using the application installed on the first remote desktop.

Accordingly, there is a need in the art for improved remote display techniques to launch a remote file with a local application.

It should be noted that the information included in the Background section herein is simply meant to provide a reference for the discussion of certain embodiments in the Detailed Description. None of the information included in this Background should be considered as an admission of prior art.

### SUMMARY

The technology described herein provides a method of seamlessly launching at least one of applications or files located on remote desktops. The method generally includes receiving, at a connection server, application information for an application located on a first remote desktop in response to a first request from a client device to add the application to the connection server, receiving, at the connection server, from the client device, a second request to launch the application, validating, at the connection server, the second request based on credentials included in the second request, and forwarding, to the first remote desktop, the second request based on validating the second request, wherein, based on the second request, the first remote desktop launches the application for display at the client device.

Further embodiments include a non-transitory computer-readable storage medium storing instructions that, when executed by a computer system, cause the computer system to perform the method set forth above, and a computer system including at least one processor and memory configured to carry out the method set forth above.

### BRIEF DESCRIPTION OF THE DRAWINGS

FIG. 1 depicts a block diagram of a virtualized desktop infrastructure (VDI) system in which one or more embodiments of the present disclosure may be implemented.

FIG. 2 illustrates an example client device, connection server, and remote desktops configured for accessing and launching applications and/or files from the remote desktops seamlessly at the client device, according to an example embodiment of the present disclosure.

FIGS. 3A and 3B illustrate an example client user interface (UI) for selecting remote desktop applications and/or files added to a connection server, according to an example embodiment of the present disclosure.

FIG. 4 is a call flow diagram illustrating example signaling for adding a remote desktop application and a remote desktop file to an example connection server, according to an example embodiment of the present disclosure.

FIG. 5 is a call flow diagram illustrating example signaling for opening a file located on a first remote desktop using an application installed on a second remote desktop, according to an example embodiment of the present disclosure.

FIG. 6 is a flow diagram illustrating example operations for launching local applications seamlessly from a remote desktop, according to an example embodiment of the present application.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for sending a command, from a local client device, to launch (e.g., open, run, etc.) remote desktop applications and/or files at one or more remote desktops such that visual features associated with the remote desktop applications and/or files are rendered at the local client device in a seamless manner (e.g., using a seamless window feature). Remote desktop applications and/or files accessed using the seamless window feature may emulate the behavior of local applications and/or files, thereby creating a consistent look and feel for a user accessing and/or interacting with the remote desktop application and/or files. In other words, the seamless window feature may cause an application and/or file launched on a remote desktop to appear as if the application and/or file is launched locally. As used herein, “seamlessly launched” (interchangeably referred to herein as “launch”) refers to operations for (1) launching remote desktop applications and/or files on a remote desktop where the applications and/or files or located and (2) rendering visual features associated with the remote desktop applications and/or files at a local client device. The remote desktop applications and/or files may be seamlessly launched without the local client device directly establishing connection(s) to remote desktop(s) where the applications and/or files are located (e.g., installed, saved, etc.). Instead, aspects allow a user to add the remote desktop applications and/or files, from one or multiple remote desktops, to a connection server, such as by adding information for the remote desktop applications and/or files on the one or more remote desktops to the connection server. At a later time (e.g., when a client device of the user is disconnected from the one or more remote desktops and connected to the connection server), the user may select one or more of these remote desktop applications and/or files added to the connection server, to be seamlessly launched at a local client device, such as by accessing via the connection server, the one or more remote desktop applications and/or files on the one or more remote desktops. In other words, selected remote desktop applications and/or files may be seamlessly launched such that the remote desktop applications and/or files appear as though they are located and launched on the local client device.

As used herein, a remote desktop file may refer to an object on a remote desktop that stores data, information, settings, commands, and/or the like, which may be used, for example, with a remote desktop application or a local application. Further, as used herein, a remote desktop application may refer to a software application installed on a remote desktop, while a local application may refer to a software application installed on a local client device. Though certain aspects are described with respect to a remote computing environment, or remote desktop applications and/or files, the techniques described herein may similarly be used with any suitable applications and/or files of any suitable computing environment.

In certain aspects, a local client device, a connection server, and one or more remote desktops perform operations to add information for remote desktop applications and/or files to the connection server. As described in more detail below, a connection server may be responsible for authenticating users, managing remote desktop and application sessions, establishing secure connections between users and remote desktops and applications, and setting and applying policies for remote desktop sessions. As an illustrative example, a user of a first remote desktop (e.g., after connection of a user's local client device to the first remote desktop) may select (e.g., via the local client device) an application and/or file on the first remote desktop to add to the connection server. Similarly, the user may connect to a second remote desktop and select (e.g., via the local client device) an application and/or file on the second remote desktop to add to the connection server. As used herein, adding an application and/or file on a remote desktop to the connection server comprises adding information for the application and/or file (e.g., application/file name, location path, the remote desktop where the file is located, and/or etc.) to the connection server, as opposed to adding the application and/or file itself. Accordingly, the connection server may include, at least, an application and/or file from the first remote desktop and an application and/or file from the second remote desktop after selection by the user.

In certain aspects, a local client device, a connection server, and one or more remote desktops perform operations to seamlessly launch remote desktop applications and/or files which have been added to the connection server. In particular, with respect to the previous example, a user of the local client device can launch the application and/or file from the first remote desktop, or an application and/or file from the second remote desktop, which have been added to the connection server. The user may launch one or more of these remote desktop applications and/or files added to the connection server by selecting the desired remote desktop applications and/or files from a client user interface (UI) on a local client device (e.g., when the local client device is connected to the connection server). The user may select one or more of the remote desktop applications and/or files to be seamlessly launched at the local client device. The selected applications and/or files may be launched even where the local client device is not directly connected to the remote desktop(s) where the selected applications and/or files are located.

In certain aspects, a local client device, a connection server, and one or more remote desktops perform operations to launch a file located on a first remote desktop using an application installed on a second remote desktop. As an illustrative example, the local client device, the connection server, a first remote desktop, and a second remote desktop perform operations to allow a user to locally (e.g., at the local client device) edit documents located on a second remote desktop using a particular word processing application installed on the first remote desktop. Visual features associated with the application launched on the first remote desktop and the filed launched on second remote desktop may be rendered at the local device to allow for such (seamless) interaction with the application and the file by the user.

The techniques presented herein may provide seamless remote working experience for users working with remote desktop applications and/or remote desktop files. Aspects may remove the need for a user to switch between remote desktop windows and local desktop windows, thereby saving time and improving user productivity. Further, aspects allow a user to launch remote desktop applications and/or files located on multiple remote desktops without needing to connect to each of these remote desktops directly for launch. Lastly, aspects allow a user to use applications on one remote desktop to open files located on another remote desktop.

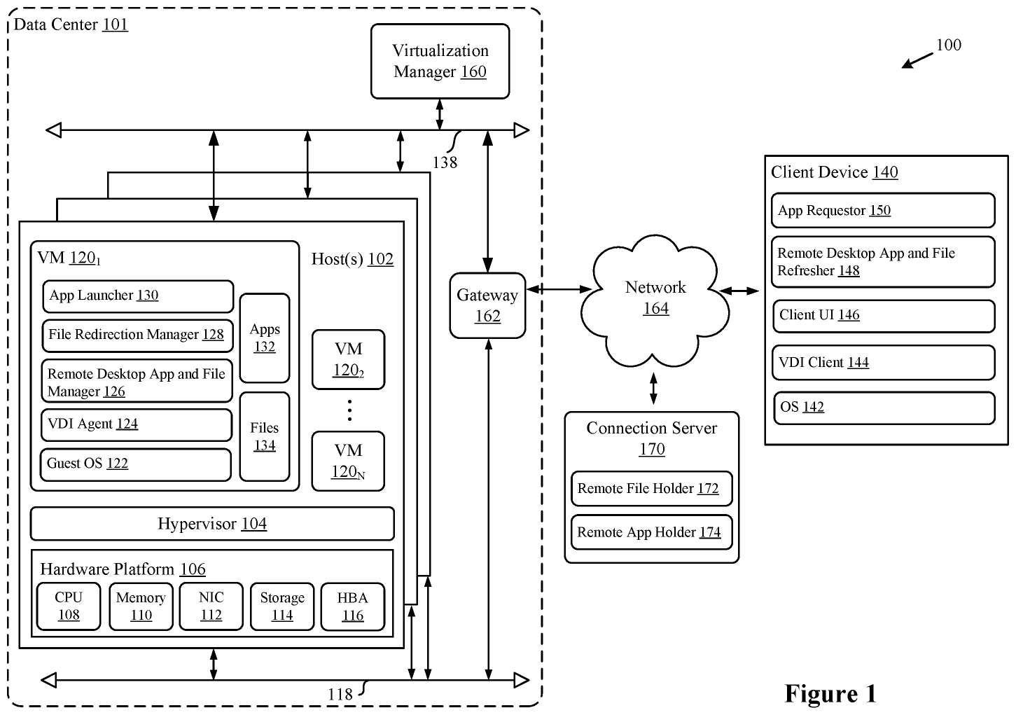

FIG. 1 depicts a block diagram of a virtual desktop infrastructure (VDI) system 100 in which one or more embodiments of the present disclosure may be implemented. VDI system 100 comprises a client device 140, one or more connection servers 170, and a data center 101, connected by a network 164. Network 164 may be, for example, a direct link, a local area network (LAN), a wide area network (WAN) such as the Internet, another type of network, or any combination thereof.

Client device 140 is a physical device, such as a general purpose desktop computer or mobile computer. A mobile computer may be, for example, a laptop, a mobile phone, or a tablet computer. Client device 140 includes operating system (OS) 142, a VDI client 144, a client UI 146, a remote desktop application (app) and file refresher 148, and an application requestor 150. In certain aspects, VDI client 144 runs on top of OS 142. OS 142 may be a standard, commodity operating system.

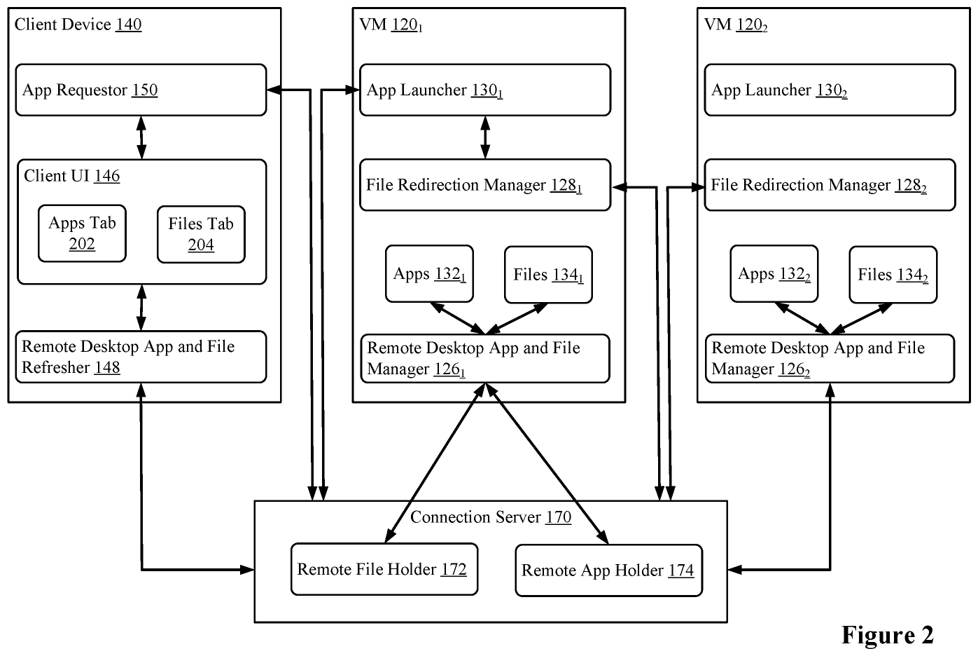

Client UI 146, remote desktop application and file refresher 148, and application requestor 150 are described in more detail below with respect to FIG. 2.

VDI client 144 is a user-side interface of a virtualized desktop running on one of virtual machines (VMs) 120. As used herein, a “virtualized desktop” or “remote desktop” is a desktop running on one of VMs 120 that is displayed remotely on client device 140, as though the remote desktop were running on client device 140. One example of a remote desktop application is Horizon Client™ made commercially available from VMware, Inc. of Palo Alto, Calif. By opening VDI client 144, a user of client device 140 accesses, through network 164, a remote desktop running in remote data center 101, from any location, using client device 140. Frames of the remote desktop running on VM 120 are transmitted to VDI client 144 at a certain frame rate using a remote display protocol such as VMware® Blast™, or Microsoft® Remote Desktop Protocol (RDP)™. After transmission, the frames are displayed on client device 140 for interaction by a user. Client device 140 sends user inputs to VM 120 for processing on VM 120, thereby taking processing load off client device 140. Such centralized and automated management of remote desktops provides increased control and cost savings. VDI client 144 may be, for example, VMware® View™, or a special purpose thin client such as those available from Dell, HP, NEC, Sun Microsystems, Wyse, and others.

As the user interacts with the virtual desktop, such as using a mouse and keyboard, the user input is redirected by VDI client 144 to VDI agent 124.

Data center 101 includes host(s) 102, a virtualization manager 160, a gateway 162, a management network 138, and a data network 118. Although the management and data network are shown as separate physical networks, in some implementations, management network 138 is logically isolated from data network 118 using different VLAN identifiers. Each of hosts 102 may be constructed on a server grade hardware platform 106, such as an x86 architecture platform. For example, hosts 102 may be geographically co-located servers on the same rack.

Host 102 is configured to provide a virtualization layer, also referred to as a hypervisor 104, that abstracts processor, memory, storage, and networking resources of hardware platform 106 into multiple VMs 120₁ to 120_{N} (collectively referred to herein as VMs 120 and individually referred to herein as VM 120) that run concurrently on the same host 102. Hypervisor 104 may run on top of the OS in host 102. In certain aspects, hypervisor 104 can be installed as system level software directly on hardware platform 106 of host 102 (often referred to as “bare metal” installation) and be conceptually interposed between the physical hardware and the guest OSs 122 executing in VMs 120. In some implementations, hypervisor 104 may comprise system level software as well as a “Domain 0” or “Root Partition” VM, which is a privileged machine that has access to the physical hardware resources of host 102. In this implementation, one or more of a virtual switch, virtual tunnel endpoint (VTEP), etc., along with hardware drivers, may reside in the privileged VM. Although the disclosure is described with reference to VMs 120, the teachings herein also apply to other types of virtual computing instances (VCIs), such as containers, Docker containers, data compute nodes, isolated user space instances, namespace containers, and the like. One example of hypervisor 104 that may be used is a VMware ESXi™ hypervisor provided as part of the VMware vSphere® solution made commercially available from VMware, Inc. of Palo Alto, Calif.

Each VM 120 includes a guest OS 122, a VDI agent 124, a remote desktop application and file manager 126, a file redirection manager 128, and an application launcher 130. Further, each VM 120 may contain applications 132 and/or files 134 (e.g., located on a remote desktop running on VM 120. VDI agent 124, remote desktop application and file manager 126, file redirection manager 128, application launcher 130, applications 132, and files 134 run on top of guest OS 122. Guest OS 122 may be a standard, commodity operating system. An application 132 may be any software program, such as a word processing program. A file 134 may be any object that stores data, information, settings, commands, and/or the like.

VDI agent 124 is a desktop virtualization program that connects to VDI client 144 of client device 140, through network 164. The connection between VDI agent 124 and VDI client 144 may be authenticated, such as through a username and password combination pertaining to client device 140 or to a user of client device 140. VDI agent 124 transmits, to VDI client 144, image frames of the remote desktop running on VM 120 that contains VDI agent 124. An image frame includes information on appearance of the remote desktop running on VM 120, and that information includes pixel color and location information. In addition to an image frame, VDI agent 124 may also transmit metadata of that frame to VDI client 144. The metadata may include x and y coordinate locations of a mouse cursor, x and y coordinates and size of windows of application(s) 132 open on the remote desktop, which application(s) 132 are running on and/or displayed on the remote desktop of VM 120, and other information

Remote desktop application and file manager 126, file redirection manager 128, and application launcher 130 are described in more detail below with respect to FIG. 2.

Hardware platform 106 of each host 102 includes components of a computing device such as one or more processors (CPUs) 108, memory 110, a network interface card including one or more network adapters, also referred to as Network Interface Cards (NICs) 112, storage system 114, a host bus adapter (HBA) 116, and other input/output (I/O) devices such as, for example, a mouse and keyboard (not shown). CPU 108 is configured to execute instructions, for example, executable instructions that perform one or more operations described herein and that may be stored in memory 110 and in storage system 114. NIC 112 enables host 105 to communicate with other devices via a communication medium, such as management network 138 and/or data network 118. Storage system 114 represents persistent storage devices (e.g., one or more hard disks, flash memory modules, solid state disks (SSDs), and/or optical disks). HBA 116 couples host 102 to one or more external storages (not shown), such as a storage area network (SAN). Other external storages that may be used include network-attached storage (NAS) and other network data storage systems, which may be accessible via NIC 112.

Memory 110 is hardware allowing information, such as executable instructions, configurations, and other data, to be stored and retrieved. Memory 110 is where programs and data are kept when CPU 108 is actively using them. Memory 110 may be volatile memory or non-volatile memory. Volatile or non-persistent memory is memory that needs constant power in order to prevent data from being erased. Volatile memory describes conventional memory, such as dynamic random access memory (DRAM). Non-volatile memory is memory that is persistent (non-volatile). Non-volatile memory is memory that retains its data after having power cycled (turned off and then back on). Non-volatile memory is byte-addressable, random access non-volatile memory.

Virtualization manager 160 communicates with hosts 102 via a network, shown as management network 138, and carries out administrative tasks for data center 101 such as managing hosts 102, managing VMs 120 running within each host 102, provisioning VMs 120, migrating VMs 120 from one host 102 to another host 102, and load balancing between hosts 102. Virtualization manager 160 may be a computer program that resides and executes in a server in data center 101 or, alternatively, virtualization manager 160 may run as a virtual appliance (e.g., a VM 120) in one of hosts 102. One example of a virtualization manager is the vCenter Server™ product made available from VMware, Inc. of Palo Alto, Calif.

Gateway 162 provides VMs 120 and other components in data center 101 with connectivity to network 164. Gateway 162 may manage external public internet protocol (IP) addresses for VMs 120, route traffic incoming to and outgoing from data center 101, and provide networking services, such as firewalls, network address translation (NAT), dynamic host configuration protocol (DHCP), and load balancing. Gateway 162 uses data network 118 to transmit data network packets to hosts 102. Gateway 162 may be a VCI, a physical device, or a software module running within host 102. Gateway 162 may include two gateways: a management gateway for management network 138 and a data gateway for data network 118.

Connection server(s) 170 may run between data center 101 and client device 140. In some embodiments, connection server(s) 170 are in communication with data center 101 and client device 140 via network 164. Connection server(s) 170 may be responsible for authenticating users, managing remote desktop and application sessions, establishing secure connections between users and remote desktops and applications, setting and applying policies for remote desktop sessions, and facilitating communications between local client devices and remote desktops. In certain aspects, connection server 170 may be configured to verify a client device 140. In certain aspects, connection server 170 may be configured to receive and store remote desktop application and/or remote desktop file information from remote desktops running on VMs 120.

For example, in certain aspects, connection server 170 comprises a remote file holder 172. Remote file holder 172 is a component designed to store and maintain information for one or more remote desktop files 134. A user may add information for a remote desktop file 134 to remote file holder 172 via a context menu, when the user is connected to the remote desktop where the file 134 is located. A context menu is a menu in a graphical UI (GUI) that appears upon user interaction (e.g., accessed by double-clicking or right-clicking a remote desktop application icon or a remote desktop file icon via a mouse or touchpad operation). The context menu may offer the user one or more remote desktop files 134 to select. Selection of one or more of the remote desktop files 134 may send information for the one or more selected remote desktop files 134 to connection server 170 to be saved in remote file holder 172. The file information saved in remote file holder 172 may include a file name, location path, icon, extension association, a user associated with the file (e.g., belonging to the file), the remote desktop where the file is located, and/or the like.

In certain aspects, connection server 170 comprises a remote application holder 174. Remote application holder 174 is a component designed to store and maintain information for one or more remote desktop applications 132. A user may add information for a remote desktop application 132 to remote application holder 174 via a context menu, when the user is connected to the remote desktop where the application 132 is located. The context menu may offer the user one or more remote desktop applications 132 to select. Selection of one or more of the remote desktop applications 132 may send information for the one or more selected remote desktop applications 132 to connection server 170 to be saved in remote application holder 174. The information saved for an application 132 in remote application holder 174 may include the application's name, executable path, icon, version, a user associated with the application (e.g., belonging to the application), the remote desktop where the application is located, and/or the like. In certain aspects, the information saved for an application 132 in remote application holder 174 includes a list of one or more files recently accessed and/or opened by the application.

In certain aspects, file information (e.g., a file name and/or a file icon) maintained and stored in remote file holder 172 is provided to client device 140, and more specifically client UI 146 on client device 140, for display to a user. In certain aspects, application information (e.g., an application name and/or an application icon) maintained and stored in remote application holder 174 is provided to client device 140, and more specifically client UI 146 on client device 140, for display to the user. For example, each time a user successfully connects client device 140 to connection server 170, remote file holder 172 and/or remote application holder 174 send remote desktop file and/or application information, stored at each holder respectively, to connection server 170. Connection server 170 then sends this information to client UI 146 on client device 140. As described in more detail below, remote desktop file and/or application information displayed to a user on client UI 146 may allow the user to select one or more remote desktop files and/or applications for launch, without directly connecting to each of their respective remote desktops (e.g., where the selected file or application is located).

FIG. 2 illustrates an example client device, connection server, and remote desktops configured for accessing and launching applications and/or files from the remote desktops seamlessly at the client device, according to an example embodiment of the present disclosure.

As mentioned with respect to FIG. 1, client device 140 includes client UI 146, remote desktop application and file refresher 148, and an application requestor 150, while each remote desktop running on each VM 120 includes a remote desktop application and file manager 126, a file redirection manager 128, and an application launcher 130. Further, connection server 170 includes remote file holder 172 and remote application holder 174. Each of these components are illustrated in FIG. 2.

Prior to a user being able to access and launch remote desktop applications and/or files (e.g., from one or more remote desktops, while not directly connected to the one or more remote desktops), the remote desktop applications and/or files may need to be added to client UI 146 on client device 140. Remote desktop application and file manager 126 on VM 120, connection server 170 including remote file holder 172 and remote application holder 174, and remote desktop application and file refresher 148 on client device 140 may be configured to add remote desktop applications and/or files, from one or more remote desktops, to client UI 146 on client device 140.

In particular, remote desktop application and file manager 126 on VM 120 may be registered with a “Send to” option on a context menu, such that when a user selects an application 132 and/or a file 134 on a remote desktop (e.g., on VM 120) to “Send to” (e.g., add to) connection server 170, the user's selection is sent to remote desktop application and file manager 126. Remote desktop application and file manager 126 may be configured to retrieve application information for a selected application 132 and/or retrieve file information for a selected file 134 (e.g., that is identified in the selection received by remote desktop application and file manager 126), and send this information to connection server 170.

As mentioned, file information for a selected file 134 that is sent to connection server 170, may be saved and stored in remote file holder 172 at connection server 170. Further, application information for a selected application 132 that is sent to connection server 170, may be saved and stored in remote application holder 174. In certain aspects, file information maintained and stored in remote file holder 172 and/or remote application holder 174 is provided to client device 140 via remote file holder 172 and/or remote application holder 174. Specifically, this information may be provided to remote desktop application and file refresher 148 on client device 140.

Remote desktop application and file refresher 148 may be configured to (1) receive remote desktop application and/or file information from connection server 170 and (2) push this received information to client UI 146 for display to a user. In certain aspects, remote desktop application and file refresher 148 performs such actions when a user selects a new (e.g., not previously added) application 132 and/or file 134 to be added to connection server 170. In certain aspects, remote desktop application and file refresher 148 performs such actions when a user removes a previously-added application 132 and/or file 134 from connection server 170. In certain aspects, remote desktop application and file refresher 148 performs such actions when a client device 140 establishes a connection with connection server 170 (and remote desktops running on VMs 120).

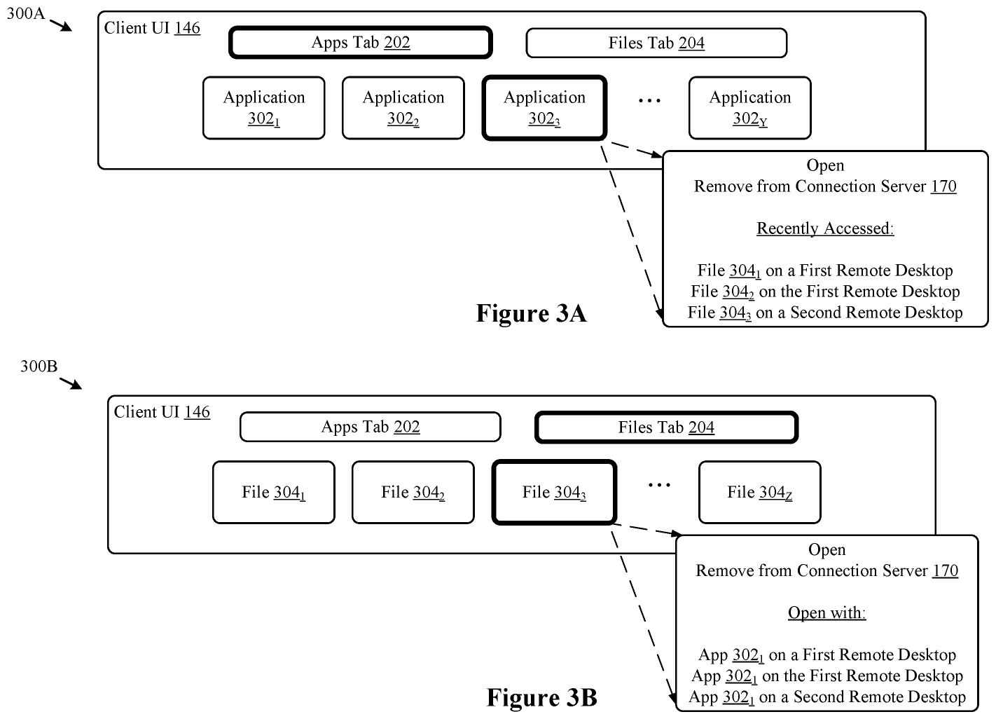

Client UI 146 is the mechanism by which a user interacts with remote desktop applications 132 and/or remote desktop files 134 added to connection server 170. In certain aspects, client UI 146 includes an applications tab 202 and/or a files tab 204. FIGS. 3A and 3B illustrate example client user interface (UI) 300A, 300B, respectively, for selecting remote desktop applications and/or files added to a connection server, according to an example embodiment of the present disclosure.

As shown in FIGS. 3A and 3B, client UI 146 comprises an applications tab 202 and a files tab 204. FIG. 3A illustrates client UI 146 when a user selects applications tab 202, while FIG. 3B illustrates client UI 146 when a user selects files tab 204.

As shown in FIG. 3A, when applications tab 202 is selected by a user, information for one or more remote desktop applications 302₁302_{Y} (collectively referred to herein as applications 302 and individually referred to herein as application 302) may be displayed to the user. Applications 302 may comprise remote desktop applications from one or more remote desktops. Applications 302 may comprise remote desktop applications which a user has previously chosen to be added to connection server 170 (e.g., while connected to the corresponding remote desktop where the application is located).

Further, as shown a user may select an application 302 from the listed applications (e.g., by selecting the application's name, icon, etc. from a list of other application names, icons, etc.) displayed on client UI 146. In FIG. 3A, a user selects application 302₃. Application 302₃ may be an application on a first remote desktop (e.g., on VM 120). When the user clicks (e.g., right-clicks) on application 302₃, a pop-up window may be displayed to the user. In certain aspects, via the pop-up window, the user may select to launch application 302₃ at client device 140 (e.g., by clicking “Open” on the pop-up window). The user may select application 302₃ for launch even though local client device 140 is not directly connected to the first remote desktop (e.g., where application 302₃ is located). In certain aspects, the user may select to open a particular file recently accessed (e.g., shown as files 304₁-304₃ in FIG. 3A) when using application 302₃. The list of recently accessed files 304 may include files 304 located on different remote desktops or the same remote desktop. The list of recently accessed files 304 may include file information (e.g., name, icon, etc.) for files 304 located on a same remote desktop where application 302₃ is located. The list of recently accessed files 304 may include file information (e.g., name, icon, etc.) for files 304 located on a different remote desktop than a remote desktop where application 302₃ is located. For example, a user may select to open application 302₃ located on a second remote desktop using application 302₃ which is located on the first remote desktop. In certain aspects, via the pop-up window, the user may select to remove application 302₃ from connection server 170. In other words, the user may select to remove information associated with application 302₃ from connection server 170 (e.g., which was previously saved and stored for application 302₃). The application may not be removed, however, from the remote desktop where the application is located.

As shown in FIG. 3B, when files tab 204 is selected by a user, one or more remote desktop files 304₁-304Z (collectively referred to herein as files 304 and individually referred to herein as file 304) may be displayed to the user. Files 304 may comprise remote desktop files from one or more remote desktops. Files 304 may comprise remote desktop files which a user has previously chosen to be added to connection server 170 (e.g., while connected to the corresponding remote desktop where the file is located).

Further, as shown, a user may select a file 304 from the listed files 304 (e.g., by selecting the file's name, icon, etc. from a list of other file names, icons, etc.) displayed on client UI 146. In FIG. 3B, a user selects file 304₃. File 304₃ may be a file on a first remote desktop (e.g., on VM 120). When the user clicks file 304₃, a pop-up window may be displayed to the user. In certain aspects, via the pop-up window, the user may select to launch file 304₃ (e.g., by clicking “Open” on the pop-up window). The user may select file 304₃ for launch even though local client device 140 is not directly connected to the first remote desktop (e.g., where application 302₃ is located). In certain aspects, the user may select to launch file 304₃ using a particular application 302. For example, the pop-up window may provide the user with application information (e.g., application name, icon, etc.) for a list of applications 302 which have been previously added to connection server 170. The list of applications 302 may include application information for applications 302 located on different remote desktops or a same remote desktop. The list of applications 302 may include application information for applications 302 located on a same remote desktop where file 304₃ is located. The list of applications 302 may include application information for applications 302 located on a different remote desktop than a remote desktop where file 304₃ is located. For example, a user may select to launch file 304₃ located on the first remote desktop using application 302₃ which is located on a remote desktop. In certain aspects, via the pop-up window, the user may select to remove file 304₃ from connection server 170. In other words, the user may select to remove information associated with application 302₃ from connection server 170 (e.g., which was previously saved and stored for file 304₃). The file may not be removed, however, from the remote desktop storing the file.

The user's selection of an application 302, a file 304, or a combination thereof to be launched may be sent to an application requestor 150 at client device 140, as shown in FIG. 2. In cases where only a file 304 is selected by the user, information about a default application 302 for the file 304 may be sent to application requestor 150 at client device 140. Application requestor 150 may be configured to transmit a request to a remote desktop, where the selected application (or default application) is located, (via connections server 170) to launch the selected application (or default application). More specifically, application requestor 150 may be configured to (1) identify which remote desktop selected application is located on (or the default application is located on) using application information associated with the application (e.g., previously pushed to client device 140 by connection server 170) and (2) send a launch application request to the identified remote desktop via the connection server. Given client device 140 is directly connected to connection server 170 and not directly connected to the identified remote desktop, the request to launch the selected application is transmitted to connection server 170, and connection server 170 directs the request to the identified remote desktop. In certain aspects, the launch application request includes all information associated with the selected application, stored at client device 140. In certain aspects, the launch application request includes a subset of information associated with the selected application stored at client device 140 (e.g., only the application's name and/or the applicant's executable path). In certain aspects, the launch application request includes all, or a subset, of information associated with the selected application (or default application) and all, or a subset, of information associated with a selected file (e.g., the file's name, the file's location path, a remote desktop where the file is located, etc.) to be opened by the selected/default application.

In certain aspects, an application to be launched for opening a selected file 302, is an application local to client device 140. Accordingly, in such a case, application requestor 150 may be configured to request a remote desktop (by sending the request to connection server 170 and connections server 170 forwarding the request to the remote desktop), where the selected file is located, to launch the selected file such that it can be opened by the local application on client device 140.

Application requestor 150 may request the remote desktop, via connection server 170, to launch the selected application (or default application) using a seamless window feature. With the seamless window feature, a user may interact with the selected application (or default application) that is running on the remote desktop as if it was a locally running application on local client device 140.

The launch application request, transmitted by application requestor 150 to connection server 170 and forwarded by connection server 170, may be received by an application launcher 130 on a remote desktop where the selected/default application is located. For example, in cases where a user selects a first application located on a first remote desktop, the request may be received (e.g., from connection server 170) by application launcher 130 on the first remote desktop. In cases where a user selects to open a first file, located on a second remote desktop, using a first application located on a first remote desktop, the request may be received (e.g., from connection server 170) by application launcher 130 on the first remote desktop. In other words, the remote desktop which receives, from connection server 170, the application launch request may be based on the remote desktop where the application is located, not a remote desktop where the file to be opened is located (e.g., in cases where the application selected for use is not local to client device 140).

Application launcher 130 may be configured to launch an application 132 located on the remote desktop where application launcher 130 is located. More specifically, application launcher 130 may be configured to launch application 302 selected from client UI 146 or a default application, located on the remote desktop where application launcher 130 is located. Application launcher 130 may be configured to launch application 132 using the seamless window feature.

In cases where a user has selected, via client UI 146, an application 302 and a file 304, to be opened by application 302, that are on different remote desktops (e.g., application 302 is located on a first remote desktop and file 304 is located on a second remote desktop), application launcher 130 may be configured to transmit a request to a file redirection manager 128, located on the same remote desktop as application launcher 130. The request may ask file redirection manager to communicate with a file redirection manager 128 on another remote desktop, and more specifically, the remote desktop where file 304 is located. Communication between file redirection managers 128 may be requested such that file 304 may be shared between the two remote desktops, thereby allowing application 302 to launch file 304 located on the other desktop.

File redirection manager 128 on a first remote desktop (e.g., shown on VM 120 1 in FIG. 2) may be configured to communicate with a file redirection manager 128 on a second remote desktop (e.g., shown on VM 120₂ in FIG. 2) to share a remote file 304 between the two remote desktops. More specifically, the file redirection manager 128 on the first remote desktop may communication with the file redirection manager 128 on the second remote desktop through connection server 170. For example, a user may select, via client UI 146, to launch a file 304 located on the second remote desktop using an application 302 located on the first remote desktop. Accordingly, file redirection manager 128₁ on the first remote desktop may communicate with file redirection manger 128₂ on the second remote desktop, via connection server 170, such that file 304 on the second remote desktop is shared with the first remote desktop. In certain aspects, prior to establishing a connection between file redirection manager 128₁ on the first remote desktop and file redirection manger 128₂ on the second remote desktop for communication between the two components, each file redirection manager 128 may request and seek approval for communication from connection server 170, using the user's credentials. Where the file is successfully shared between the first and second remote desktops (using connection server 170), application launcher 130 on the first remote desktop may be configured to open file 304 from the second remote desktop via application 132 on the first remote desktop, using the seamless window feature.

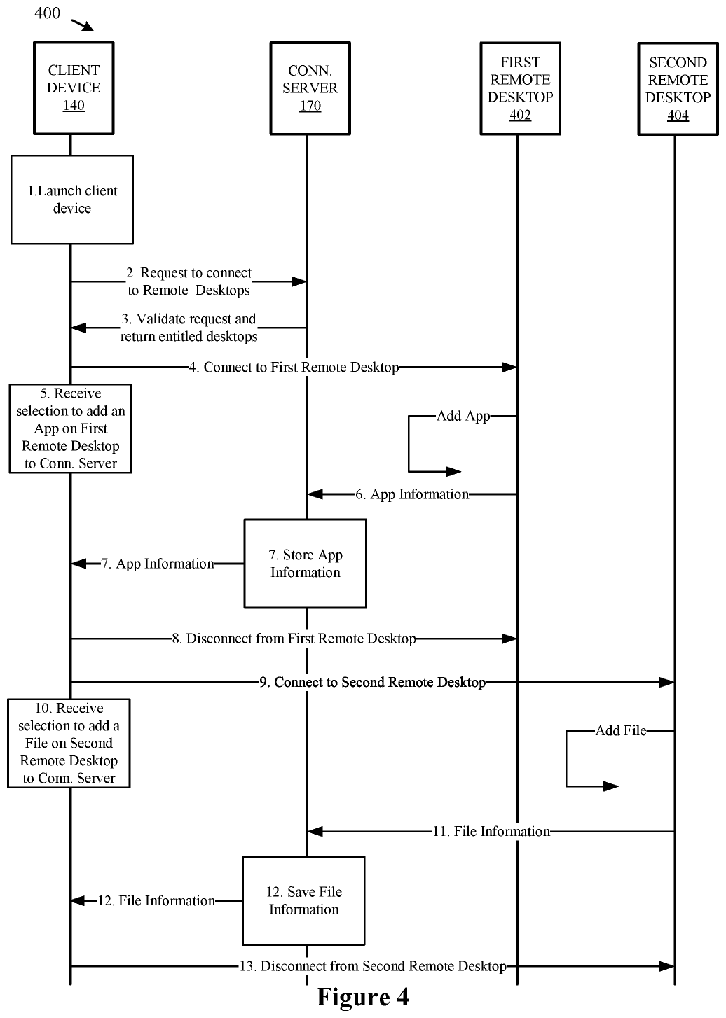

FIG. 4 is a call flow diagram 400 illustrating example signaling for adding a remote desktop application and a remote desktop file to an example connection server, according to an example embodiment of the present disclosure. As shown, steps 1 through 13 illustrated in FIG. 4 may be performed by client device 140, connection server 170, a first remote desktop 402 (e.g., running on a first VM, such as VM 120₁ illustrated FIG. 2), and a second remote desktop 404 (e.g., running on a second VM, such as VM 120₂ illustrated FIG. 2).

Though FIG. 4 illustrates adding a single application, such as application 132 illustrated in FIG. 1, located on first remote desktop 402 to connection server 170, similar operations illustrated in FIG. 2 may also be used to (1) add other applications 132 on first remote desktop 402 and/or (2) add other applications 132 on other remote desktops connected to client device 140. Further, though FIG. 4 illustrates adding a single file, such as file 134 illustrated in FIG. 1, located on second remote desktop 404 to connection server 170, similar operations illustrated in FIG. 2 may also be used to (1) add other files 134 on second remote desktop 404 and/or (2) add other files 134 on other remote desktops connected to client device 140.

Call flow diagram 400 begins, at step 1, by a user launching client device 140. As mentioned, client device 140 may be a general purpose desktop computer or mobile computer. Thus, at step 1, the user may turn on and begin operating the general purpose desktop computer or mobile computer. At step 2, client device 140 requests, from connection server 170, connection to one or more remote desktops. In this example, client device 140 requests connection to first remote desktop 402 and second remote desktop 404. As mentioned, connection server 170 may be responsible for authenticating a user and establishing secure connections between a user (e.g., a client device 140 being used by the user) and remote desktops. In response to the request, at step 3, connections server 170 validates client device 140′s request to connect and returns a list of desktops which client device 140 is able to connect with, e.g., first remote desktop 402 and second remote desktop 404.

At step 4, client device 140 connects to first remote desktop 402. For this example, a user may connect to first remote desktop 402 to add an application 132 on first remote desktop 402 to connection server 170. Accordingly, at step 5, client device 140 receives a request from the user to add an application 132 on first remote desktop 402 to connection server 170. The request may be received by client device 140 via a context menu, when the user is connected to first remote desktop 402. Because client device 140 is connected to first remote desktop 402, at step 6, first remote desktop 402 transmits application information for application 132 to connection server 170.

At step 7, application information for application 132 is stored on connection server 170, and more specifically, stored in remote application holder 174 on connection server 170. When application information for application 132 is stored in remote application holder 174, remote application holder 174 may be triggered to provide this application information to client device 140, such that application 132 is represented as an application 302 icon on client UI 146, as previously described with respect to FIG. 3A (e.g., for subsequent user selection).

At step 8, client device 140 disconnects from first remote desktop 402 (e.g., such that client device 140 is not directly connected to first remote desktop 402).

Subsequently, at step 9, client device 140 connects to second remote desktop 404. For this example, a user may connect to second remote desktop 404 to add a file 134 on second remote desktop 404 to connection server 170. Accordingly, at step 10, client device 140 receives a request from the user to add a file 134 on second remote desktop 404 to connection server 170. The request may be received by client device 140 via a context menu, when the user is connected to second remote desktop 404. Because client device 140 is connected to second remote desktop 404, at step 11, second remote desktop 404 transmits file information for file 134 to connection server 170.

At step 12, file information for file 134 is stored on connection server 170, and more specifically, stored in remote file holder 172 on connection server 170. When file information for file 134 is stored in remote file holder 172, remote file holder 172 may be triggered to provide this file information to client device 140, such that file 134 is represented as a file 304 icon on client UI 146, as previously described with respect to FIG. 3B (e.g., for subsequent user selection).

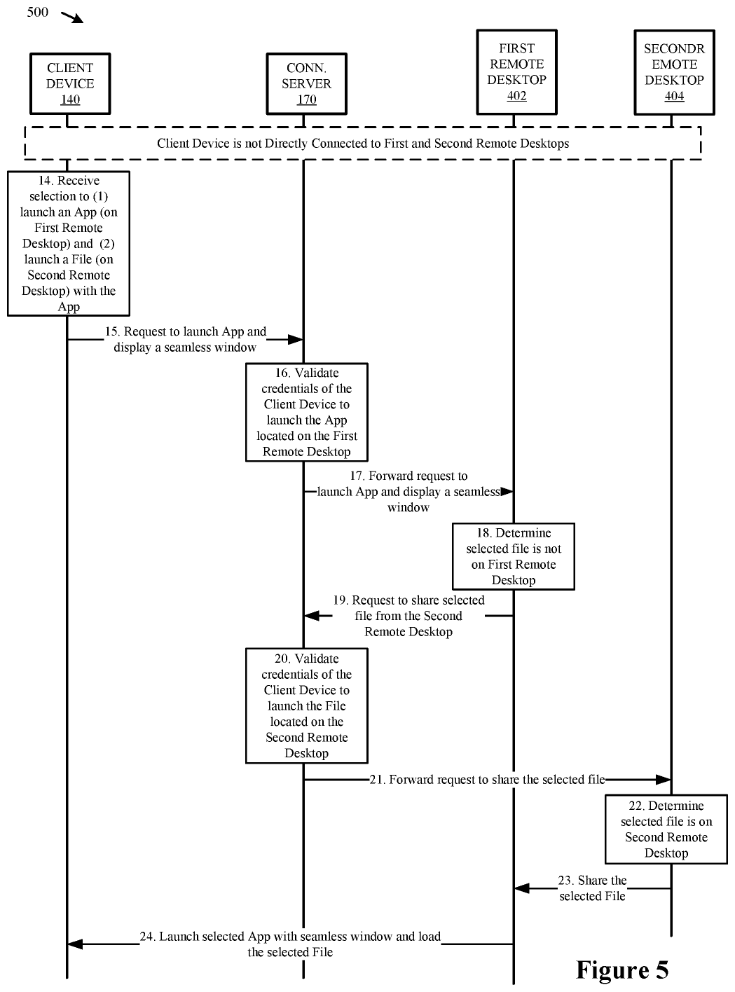

At step 13, client device 140 disconnects from second remote desktop 404 (e.g., such that client device 140 is not directly connected to second remote desktop 404). After steps 1 through 13, illustrated in FIG. 4, are complete, client UI 146 may include the added application 302 (e.g., on first remote desktop 402) and the added file 304 (e.g., on second remote desktop 404), and more specifically, application information (e.g., a name, an icon, and/or etc.) for the added application 302 and file information (e.g., a name, an icon, and/or etc.) for the added file 304. As illustrated with respect to FIG. 5, a user may, at a later time, select application 302 and file 304 on client UI 146, such that file 304 on second remote desktop 404 is launched with application 302 on first remote desktop 402.

FIG. 5 is a call flow diagram 500 illustrating example signaling for launching a file located on a second remote desktop using an application installed on a first remote desktop, according to an example embodiment of the present disclosure. Similar to steps 1 through 13 illustrated in FIG. 4, steps 14 through 20 illustrated in FIG. 5 may also be performed by client device 140, connection server 170, first remote desktop 402 (e.g., running on a first VM, such as VM 120₁ illustrated FIG. 2), and second remote desktop 404 (e.g., running on a second VM, such as VM 120₂ illustrated FIG. 2). Steps 1 through 13 illustrated in FIG. 4 may be performed while client device 140 is directly disconnected from both first remote desktop 402 and second remote desktop 404, but it directly connected to connection server 170.

Though FIG. 5 illustrates launching file 134 on second remote desktop 404 (e.g., previously added to client UI 146 as file 304) using application 132 on first remote desktop 402 (e.g., previously added to client UI 146 as application 302), similar steps illustrated in FIG. 5 may also be used to launch one or more other files 304 using one or more other applications 302 or a local application on client device 140, the files 304 and applications 302 being located on the same or different remote desktops.

Call flow diagram 500 begins, at step 14, by client device 140 receiving a selection, from a user, to (1) launch an application 132 located on first remote desktop 402 and (2) launch a file 134 located on second remote desktop 404 using application 132. For example, the user may make this selection by selecting application 302 icon (e.g., representative of application 132 located on first remote desktop 402) on client UI 146 and choosing file 134 from a list of recently accessed files presented in a pop-up window after selecting the application 302 icon. In another example, the user may make this selection by selecting file 304 icon (e.g., representative of file 134 located on second remote desktop 404) on client UI 146 and choosing application 132 from a list of applications which may be used to open file 134 that are presented in a pop-up window after selecting the file 304 icon.

At step 15, client device 140 requests first remote desktop 402 to launch application 132 (e.g., the selected application) located on first remote desktop 402. More specifically, at step 15, client device 140 transmits a request to connection server 170 to launch application 132. In certain aspects, the request to launch application 132 includes credentials of the client device. At step 16, connection server 170 validates the credentials of the client device to access and launch application 132 on the first remote desktop. For example, connection server 170 is configured to audit the validity of the request to manage access to resources (e.g., applications and/or files) on one or more remote desktops, including first remote desktop 402 and second remote desktop 404.

At step 16, connection server 170 uses the credentials to connect to first remote desktop 402 on behalf of client device 140 and forwards the request, to first remote desktop 402, to launch application 132, based on validating the credentials. Client device 140 may request (e.g., via connection server 170) first remote desktop 402 to launch application 132 and display a seamless window. In the request, client device 140 may include application information associated with application 132, as well as file information associated with file 134, which is to be opened by application 132.

At step 18, first remote desktop 402 (and more specifically, application launcher 130 on first remote desktop 402, as described with respect to FIG. 2) determines file 134 is not located on first remote desktop 402. First remote desktop 402 may make this determination based on file information for file 134 (e.g., indicating a remote desktop where file 134 is located) provided to remote desktop 402. First remote desktop 402 may also use this file information to determine that file 134 is located on second remote desktop 404.

Accordingly, at step 19, first remote desktop 402 transmits a request to connection server 170, requesting second remote desktop 404 to share file 134 located on second remote desktop 404 with first remote desktop 402. At step 20, connection server 170 validates the credentials of client device 140 to access and launch file 134 located on the second remote desktop. At step 21, connection server 170, uses the credentials to connect to second remote desktop 404 on behalf of client device 140 and forwards this request to second remote desktop 404, based on validating the credentials. In certain aspects, connection server 170 provides second remote desktop 404 with a session token to allow second remote desktop 404 to establish a connection with first remote desktop 402 for sharing file 134.

At step 22, second remote desktop 404 determines file 134 is, in fact, located on second remote desktop 404, and, at step 23, shares file 134 with first remote desktop 402 (e.g., sends file 134 to first remote desktop 402). In particular, second remote desktop 404 uses the session token obtained from connection server 170 to establish a session and share file 134 with first remote desktop 402. As described with respect to FIG. 2, steps 19-23 may be performed by a file redirection manger 128 on first remote desktop 402, a file redirection manger 128 on second remote desktop 404, and connection server 170.

At step 24, first remote desktop 402 launches application 132 with a seamless window feature and loads file 134 to be opened by application 132. File 134 opened by application 132 may be presented to the user of client device 140.

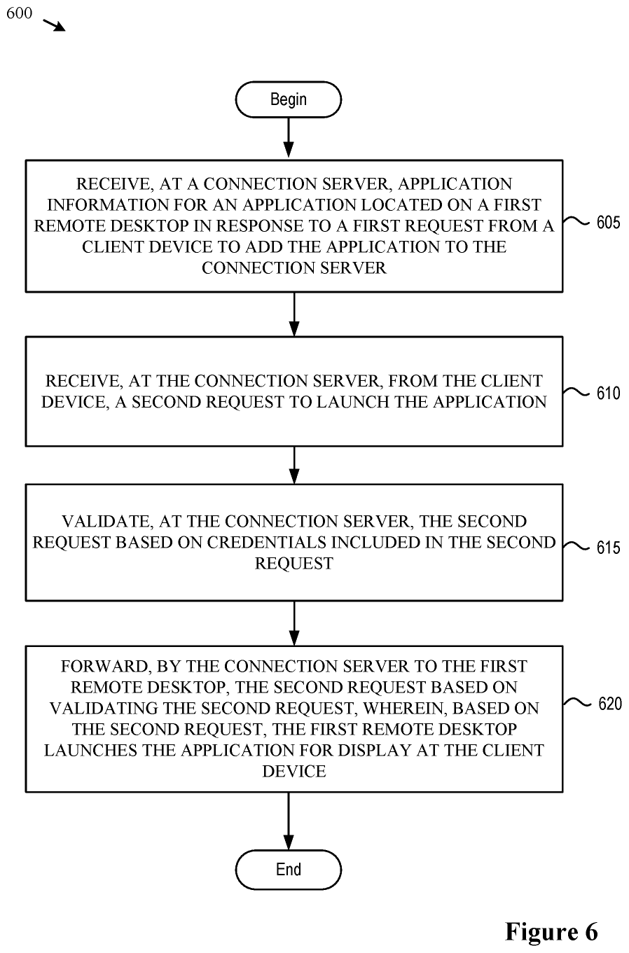

FIG. 6 is a flow diagram illustrating example operations 600 for seamlessly launching remote desktop applications (e.g., one or more remote desktop applications 132 on one or more multiple remote desktops) and/or remote desktop files (e.g., one or more remote desktop applications 132 on one or more multiple remote desktops), according to an example embodiment of the present application. Operations 600 may be performed by a connection server, such as connection server 170 illustrated in FIG. 1.

Operations 600 begin at operation 605 by a connection sever receiving application information for an application located on a first remote desktop in response to a first request from a client device to add the application to the connection server.

At operation 610, the connection server receives, from the client device, a second request to launch the application.

At operation 615, the connection server validates, at the connection server, the second request based on credentials included in the second request.

At operation 620, the connection server forwards, to the first remote desktop, the second request based on validating the second request, wherein, based on the second request, the first remote desktop launches the application for display at the client device.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of seamlessly launching at least one of applications or files located on remote desktops, the method comprising:
receiving, at a connection server, application information for an application located on a first remote desktop in response to a first request from a client device to add the application to the connection server;
receiving, at the connection server, from the client device, a second request to launch the application;
validating, at the connection server, the second request based on credentials included in the second request; and
forwarding, to the first remote desktop, the second request based on validating the second request, wherein, based on the second request, the first remote desktop launches the application for display at the client device.

2. The method of claim 1, further comprising:
receiving, at the connection server, file information for a file located on the first remote desktop or a second remote desktop in response to a third request from the client device to add the file to the connection server.

3. The method of claim 2, wherein:
the second request to launch the application comprises a request to launch the file using the application; and
based on the second request, the first remote desktop launches the file using the application for display at the client device.

4. The method of claim 3, wherein:
the second request, forwarded to the first remote desktop, comprises the application information for the application and the file information for the file, the file information for the file comprising at least an indication that the file is located on the second remote desktop. The method of claim 4, further comprising:
receiving, at the connection server, from the first remote desktop, a fourth request to obtain the file located on the second remote desktop;
validating, at the connection server, the fourth request based on credentials included in the fourth request;
forwarding, to the second remote desktop, the fourth request based on validating the fourth request, wherein the second remote desktop transmits, to the first remote desktop, the file such that the first remote desktop is able to launch the file from the first remote desktop using the application located on the first remote desktop, in response to receiving the fourth request.

6. The method of claim 4, further comprising:
transmitting, from the connection server to the client device, the application information for the application, such that a first icon for the application is added to a client user interface at the client device;
transmitting, from the connection server to the client device, the file information for the file, such that a second icon for the file is added to the client user interface at the client device,
wherein the second request to launch the file is received via:
selection, by a user of the client device, the second icon for the file; or
selection, by the user of the client device, the first icon for the application and the file from a list of recent files displayed on the client user interface for the file.

7. A system comprising:
one or more processors; and
at least one memory, the one or more processors and the at least one memory configured to cause the system to:
receive, at a connection server, application information for an application located on a first remote desktop in response to a first request from a client device to add the application to the connection server;
receive, at the connection server, from the client device, a second request to launch the application;
validate, at the connection server, the second request based on credentials included in the second request; and
forward, to the first remote desktop, the second request based on validating the second request, wherein, based on the second request, the first remote desktop launches the application for display at the client device.

8. The system of claim 7, wherein the one or more processors and the at least one memory are further configured to cause the system to:
receive, at the connection server, file information for a file located on the first remote desktop or a second remote desktop in response to a third request from the client device to add the file to the connection server.

9. The system of claim 8, wherein:
the second request to launch the application comprises a request to launch the file using the application; and
based on the second request, the first remote desktop launches the file using the application for display at the client device.

10. The system of claim 9, wherein:
the second request, forwarded to the first remote desktop, comprises the application information for the application and the file information for the file, the file information for the file comprising at least an indication that the file is located on the second remote desktop.

11. The system of claim 10, wherein the one or more processors and the at least one memory are further configured to cause the system to:
receive, at the connection server, from the first remote desktop, a fourth request to obtain the file located on the second remote desktop;
validate, at the connection server, the fourth request based on credentials included in the fourth request;
forward, to the second remote desktop, the fourth request based on validating the fourth request, wherein the second remote desktop transmits, to the first remote desktop, the file such that the first remote desktop is able to launch the file from the first remote desktop using the application located on the first remote desktop, in response to receiving the fourth request.

12. The system of claim 10, wherein the one or more processors and the at least one memory are further configured to cause the system to:
transmit, from the connection server to the client device, the application information for the application, such that a first icon for the application is added to a client user interface at the client device;
transmit, from the connection server to the client device, the file information for the file, such that a second icon for the file is added to the client user interface at the client device,
wherein the second request to launch the file is received via:
selection, by a user of the client device, the second icon for the file; or
selection, by the user of the client device, the first icon for the application and the file from a list of recent files displayed on the client user interface for the file.

13. A non-transitory computer-readable medium comprising instructions that, when executed by one or more processors of a computing system, cause the computing system to perform operations for seamlessly launching at least one of applications or files located on remote desktops, the operations comprising:
receiving, at a connection server, application information for an application located on a first remote desktop in response to a first request from a client device to add the application to the connection server;
receiving, at the connection server, from the client device, a second request to launch the application;
validating, at the connection server, the second request based on credentials included in the second request; and
forwarding, to the first remote desktop, the second request based on validating the second request, wherein, based on the second request, the first remote desktop launches the application for display at the client device.

14. The non-transitory computer-readable medium of claim 13, wherein the operations further comprise:
receiving, at the connection server, file information for a file located on the first remote desktop or a second remote desktop in response to a third request from the client device to add the file to the connection server.

15. The non-transitory computer-readable medium of claim 14, wherein:
the second request to launch the application comprises a request to launch the file using the application; and
based on the second request, the first remote desktop launches the file using the application for display at the client device.

16. The non-transitory computer-readable medium of claim 15, wherein:
the second request, forwarded to the first remote desktop, comprises the application information for the application and the file information for the file, the file information for the file comprising at least an indication that the file is located on the second remote desktop.

17. The non-transitory computer-readable medium of claim 16, wherein the operations further comprise:
receiving, at the connection server, from the first remote desktop, a fourth request to obtain the file located on the second remote desktop;
validating, at the connection server, the fourth request based on credentials included in the fourth request;
forwarding, to the second remote desktop, the fourth request based on validating the fourth request, wherein the second remote desktop transmits, to the first remote desktop, the file such that the first remote desktop is able to launch the file from the first remote desktop using the application located on the first remote desktop, in response to receiving the fourth request.

18. The non-transitory computer-readable medium of claim 16, wherein the operations further comprise:
transmitting, from the connection server to the client device, the application information for the application, such that a first icon for the application is added to a client user interface at the client device;
transmitting, from the connection server to the client device, the file information for the file, such that a second icon for the file is added to the client user interface at the client device,
wherein the second request to launch the file is received via:
selection, by a user of the client device, the second icon for the file; or
selection, by the user of the client device, the first icon for the application and the file from a list of recent files displayed on the client user interface for the file.
